(19) United States
(12) Patent Application Publication
(10) Pub. No.: US 2006/0104609 A1
(43) Pub. Date: May 18, 2006

(54) Reproducing device and method

(75) Inventors: Yoshihiro Ohmori, Kanagawa (JP); Koji Yamamoto, Kanagawa (JP); Takashi Ida, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/268,618

(22) Filed: Nov. 8, 2005

(30) Foreign Application Priority Data
Nov. 8, 2004 (JP) 2004-324257

(51) Int. Cl. H04N 5/783

(52) U.S. Cl. 386/68

(57) ABSTRACT

According to an embodiment, a reproducing device including: a unit storing pictures; a controller for controlling reproduction of the pictures; a unit displaying the pictures under controlling; a unit allowing an audience to indicate a reproducing mode such as an unmagnified speed reproduction, a fast-forwarding or the like; a calculator calculating a feature quantity from the stored pictures; a unit determining a time-wise shortened reproducing mode for a scene on basis of the calculated feature quantity; and a unit presenting the reproducing mode for a scene of the pictures under reproduction to the audience on basis of the determining. When seemingly unimportant scene is or is to be reproduced, a reproducing mode such as fast-forwarding and skipping some or whole of the scene is recommended to the audience; whereby the audience can interactively accelerate or abbreviate reproduction of the pictures and/or sounds while checking the pictures and/or sounds.

### CROSS-REFERENCE TO RELATED APPLICATIONS

This application is based on upon and claims the benefit of priority from the prior Japanese Patent Application No. 2004-324257, filed on Nov. 8, 2004; the entire contents of which are incorporated herein by reference.

### TECHNICAL FIELD

The present invention relates to a reproducing device for abbreviating or time-wise shortened reproducing of pictures or sounds recorded in an HDD recorder (hard disc recorder), DVD (Digital Versatile Disk) or a memory.

### BACKGROUND OF THE INVENTION

As a method of abbreviating and then viewing pictures is known a digest system for reproducing only important scenes, a variable-speed reproducing system for changing the reproducing speed in accordance with the importance degree of a scene or a frame, and a list display system for detecting scenes having cuts or telops.

A system disclosed in Issued Japanese Patent No. 3323842 generates digest pictures on the basis of the feature quantity automatically extracted from pictures. The feature quantity automatically extracted from the pictures does not necessarily correctly represent important scenes, and thus there is a case where a scene which a user does not want to view is adopted in digest pictures or the breaking between scenes is inaccurate and thus an important scene is halfway finished. However, the user must reluctantly view the digest pictures thus generated.

A system disclosed in Issued Japanese Patent No. 3176893 generates digest pictures on the basis of event data. The event data can be also manually input and thus it can accurately represent important scenes, so that no unimportant scene is adopted. However, the breaking between scenes is still inaccurate. Furthermore, as in the case of the Japanese Patent No. 3323842, a user cannot view a scene which is not adopted in digest pictures, but a user wants to view.

A system disclosed in Issued Japanese Patent No. 2557338 reproduces pictures while the reproducing speed the pictures is varied in accordance with the variation amount of the pictures. For example, with respect to a scene having a large variation, the pictures thereof are reproduced at a low speed. On the other hand, with respect to a scene having a small variation, the pictures thereof are reproduced at a high speed. Since all the pictures are reproduced, there is no case where some important scene is slipped over. However, fast-forwarding is automatically started for even a scene which a user wants to view in a normal reproduction mode, and thus the pictures of the scene is not necessarily reproduced at a reproduction speed meeting the user's intention.

A system disclosed in JP-A-7(1995)-192003 extracts subtitled pictures and display a list of the pictures. A user views a list of thumbnails and reproduce pictures from a desired place, so that the user can interactively abbreviate the pictures and view the pictures thus abbreviated. However, upon viewing thumbnail pictures, the user unintentionally knows the results of past games or the like, or in order to select a scene when pictures are viewed, it is necessary to display a thumbnail views, so that feeling of on-the-spot watching is lost.

As described above, the audience is not able to interactively realize a time-wise shortened reproducing of the pictures and sounds while watching and identifying the pictures.

### BRIEF SUMMARY OF THE INVENTION

According to embodiments of the present invention, a reproducing device for reproducing pictures or sounds comprises: a unit configured to acquire a time-sequential feature quantity from at least one of, the pictures, the sounds and information appended to the pictures or sounds; and a unit configured to present the feature quantity to an audience in association with position of the pictures or sounds under reproduction or with position of the pictures or sounds to be next reproduced.

According to embodiments of the present invention, a reproducing device for reproducing pictures or sounds comprises: a unit configured to acquire a time-sequential feature quantity from at least one of, the pictures, the sounds and information appended to the pictures or sounds; a unit configured to determine scenes on basis of the feature quantity and a predetermined calculation condition and determines a time-wise shortened reproducing mode of carrying out accelerated or abbreviated reproduction for each scene; and a unit configured to present the time-wise shortened reproducing mode to an audience in association with a scene of the pictures or sounds under reproduction or with a scene to be next reproduced.

According to embodiments of the present invention, a reproducing device for reproducing pictures or sounds comprises: a unit configured to receive scenes of the pictures or sounds and a time-wise shortened reproducing mode of carrying out accelerated or abbreviated reproduction for each of the scene; and a unit configured to present the time-wise shortened reproducing mode to an audience in association with one of the scenes of the pictures or sounds under reproduction or with other one of the scenes to be next reproduced.

According to the embodiments of the present invention, when seemingly unimportant scenes are or to be reproduced, an automatic or compulsorry mode of the time-wise shortened reproduction such as fast-forwarding, skipping some parts of the scenes or the like is not carried out; but the feature quantity or the reproducing method is presented to allow the audience to select an appropriate or desired mode of the reproduction. Therefore, the audience can interactively accelerate or abbreviate reproduction of the pictures and/or sounds while checking the pictures and/or sounds.

### BRIEF DESCRIPTION OF THE DRAWINGS

FIG. 1 is a diagram showing the construction of a video reproducing device according to a first embodiment of the present invention;

FIG. 2 is a diagram showing the operation of the video reproducing device according to the first embodiment;

FIG. 3 is a flowchart showing the procedure of the video reproducing device according to the first embodiment;

FIG. 4 is a diagram showing a specific example of a method of supplying an abbreviation-reproducing mode of the video reproducing device according to the first embodiment;

FIG. 5 is a diagram showing the operation of the video reproducing device of a third modification of the first embodiment;

FIG. 6 is a diagram showing the operation of the video reproducing device of a fifth modification of the first embodiment;

FIG. 7 is a diagram showing the construction of a video reproducing device according to a second embodiment of the present invention;

FIG. 8 is a diagram showing an example of an abbreviation-reproducing mode of a video reproducing method according to a second embodiment; and

FIG. 9 is a flowchart showing the video reproducing device according to the second embodiment.

### DETAILED DESCRIPTION OF THE INVENTION

Embodiments of the present invention will be described hereunder with reference to the accompanying drawings.

### FIRST EMBODIMENT

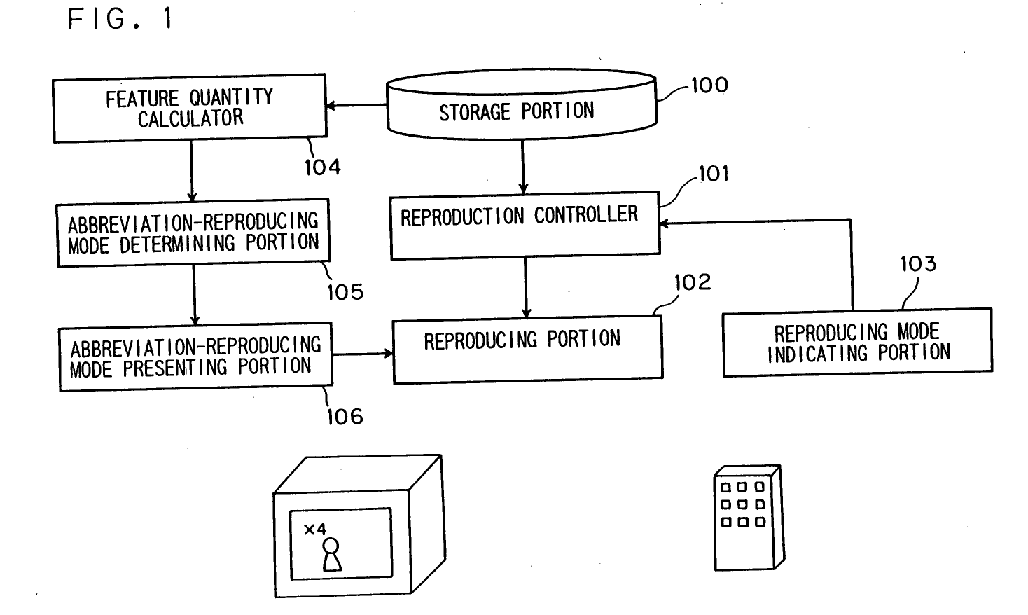

A video reproducing device according to a first embodiment of the present invention will be described with reference to FIGS. 1 to 3.

(1) Construction of Video Reproducing Device

FIG. 1 is a diagram showing the construction of the video reproducing device according to the first embodiment.

The video reproducing device according to this embodiment is constructed by adding a function or mechanism of implementing a time-wise shortened reproduction mode (hereinafter referred as abbreviation-reproducing mode) for some scenes to an ordinary video reproducing device such as a DVD player or the like.

That is, a video reproducing device equipped with: a storage portion 100 for storing pictures; a reproduction controller 101 for controlling reproduction of the pictures; a reproducing portion 102 for displaying the pictures under the control of the reproduction controller 101; and a reproducing mode indicating portion 103 for allowing the audinece to indicate a reproducing method (reproduction mode) such as unmagnified speed reproduction, fast-forwarding reproduction or the like; and additionally equipped with: a feature quantity calculator 104 for calculating a feature quantity from the stored pictures; an abbreviation-reproducing mode determining portion 105 for determining an abbreviation-reproducing mode of accelerating or abbreviating reproduction for the scenes, from the feature quantity thus calculated; and an abbreviation-reproducing mode presenting portion 106 for presenting the audience with the abbreviation-reproducing mode for the scene of the pictures under reproduction on the basis of the abbreviation-reproducing mode thus determined.

(2) Brief Description of Processing of Video Reproducing Device

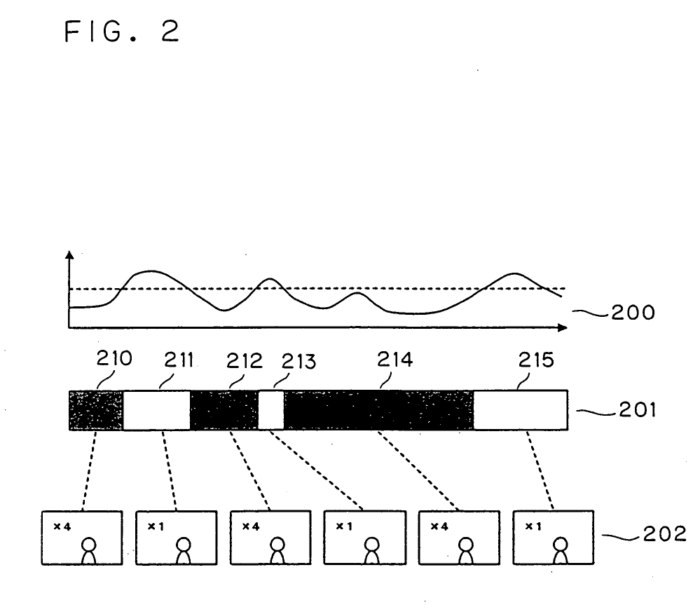

FIG. 2 is a diagram showing the processing of the video reproducing device according to the first embodiment.

The feature quantity calculator 104 is constructed by an audio recorder circuit, and reads out audio data stored in the storage portion 100 to calculate sound pressure. The uppermost part of FIG. 2 shows a graph 200 representing the sound pressure thus calculated. The abscissa axis of the graph represents the time axis, and the ordinate axis of the graph represents the magnitude of the sound pressure.

The abbreviation-reproducing mode determining portion 105 is constructed by an electronic circuit. A continuous section having sound pressure higher than a threshold value indicated by a broken line in the graph 200 and a continuous section having sound pressure smaller than the threshold value are determined as scenes. More specifically, a scene having large sound pressure is regarded as containing an important content, and thus the scene concerned is determined to be reproduced at unmagnified speed. On the other hand, a scene having small sound pressure is regarded as containing no important content, and thus the scene concerned is determined to be reproduced at a quadruple speed. The intermediate part of FIG. 2 shows a reproduction timing chart 201 representing scenes and an abbreviation-reproducing mode of the scenes; and the abscissa axis represents the time axis, white rectangle parts represent scenes at unmagnified speed and hatched or dotted rectangle parts represent scenes at a quadruple speed. Here, “scene” means a significant reproduction shot constructed by plural frames or a series of images; and for example, it is CM, a goal shot of a foot ball (soccer) match or the like.

The abbreviation-reproducing mode presenting portion 106 is constructed by a picture generating circuit, and it generates: a picture having a character sequence of “×4” when the quadruple speed reproduction is or to be represented; and a picture having a character sequence of “×1” when the unmagnified speed reproduction as shown in a reproduction screen at the lower part of FIG. 2.

The reproduction controller 101 is constructed by video and audio decoder circuits, reads out pictures and sounds stored in the storage portion 100 to decode the pictures and the sounds thus read out, and reproduces the pictures and the sounds according to an instruction of the reproducing mode indicating portion 103.

The reproducing portion 102 is constructed by a television set, and it combines the pictures and sounds decoded in the reproduction controller and the presentation of the abbreviation-reproducing mode presented by the abbreviation-reproducing mode presenting portion 106 and displays the composite data. These composite data are displayed on the reproduction screen 202. With respect to a hatched or dotted rectangular parts of the scenes drawn in the reproduction timing chart 201, the picture of a person generated by the reproduction controller 101 and the character sequence of “×4” representing the abbreviation- or accelerated-reproduction of the quadruple speed reproduction generated by the abbreviation-reproducing mode presenting portion 106 are combined with each other and displayed. On the other hand, with respect to a white rectangular parts of the scenes displayed on the reproduction screen 202, the picture of a person generated by the reproduction controller 101 and a character sequence of “×1” representing the unmagnified speed reproduction generated by the abbreviation-reproducing mode presenting portion 106 are combined and displayed.

The reproducing mode indicating portion 103 is constructed by a remote-control transmitter and a remote-control receiver, and equipped with an unmagnified speed reproduction button and a quadruple speed reproduction button. The audience inputs an instruction of reproduction by referring to the pictures and sounds displayed on the reproducing portion 102 and the presentation of the reproducing mode generated by the abbreviation-reproducing mode presenting portion 106. The instruction thus input is transmitted to the reproduction controller 101, and the pictures and sounds are reproduced in the unmagnified speed reproduction mode or a quadruple speed reproduction mode according to the instruction.

In the case of FIG. 2, when the reproduction of a section 210 is started, a character sequence of “×4” is synthesized and displayed on the screen, and when the audience pushes the quadruple speed reproduction button during reproduction of the section 210, the pictures of the section 210 are reproduced at a quadruple speed. The character sequence of “×4” is still displayed during the quadruple speed reproduction. However, when the quadruple speed reproduction advances to a section 211, a character sequence of “×1” is displayed. When the audience checks and knows that the character sequence is changed, during the quadruple speed reproduction of the section 211, and pushes the unmagnified speed reproduction button, the pictures are reproduced at unmagnified speed. The character sequence of “×1” is still displayed during even the unmagnified speed reproduction. When the unmagnified speed reproduction advances to a section 212, the display of “×1” is changed to “×4”. If the audience wants to continue to view pictures when the audience checks the pictures, the unmagnified speed reproduction is continued without deference to the presentation of the character sequence.

As described above, the abbreviation-reproducing mode presenting portion 106 merely presents and proposes the abbreviation-reproducing mode of scenes, and on the basis of this presentation and the pictures and sounds during reproduction, the audience actually judges and indicates whether the abbreviation- or accelerated-reproduction such as the quadruple speed reproduction or the like should be carried out. Conversely, even when there is no presentation of the abbreviation-reproducing mode, the reproducing mode can be returned to the normal reproducing mode during the quadruple speed reproduction for example.

In the feature quantity calculator 104, the sound pressure is set as the feature quantity, however, the sound pressure is not necessarily large at a scene which the audience wants to view.

Furthermore, in the abbreviation-reproducing mode determining portion 105, the sound pressure is screened by a threshold value. However, all the scenes which the audience wants to view cannot be necessarily extracted by using the threshold value. According to this embodiment, the abbreviation-reproduction is not automatically carried out, and thus there does not occur such a trouble that scenes are forcedly reproduced at a quadruple speed while the audience views the scenes.

(3) Procedure of Abbreviation-Reproducing Pictures

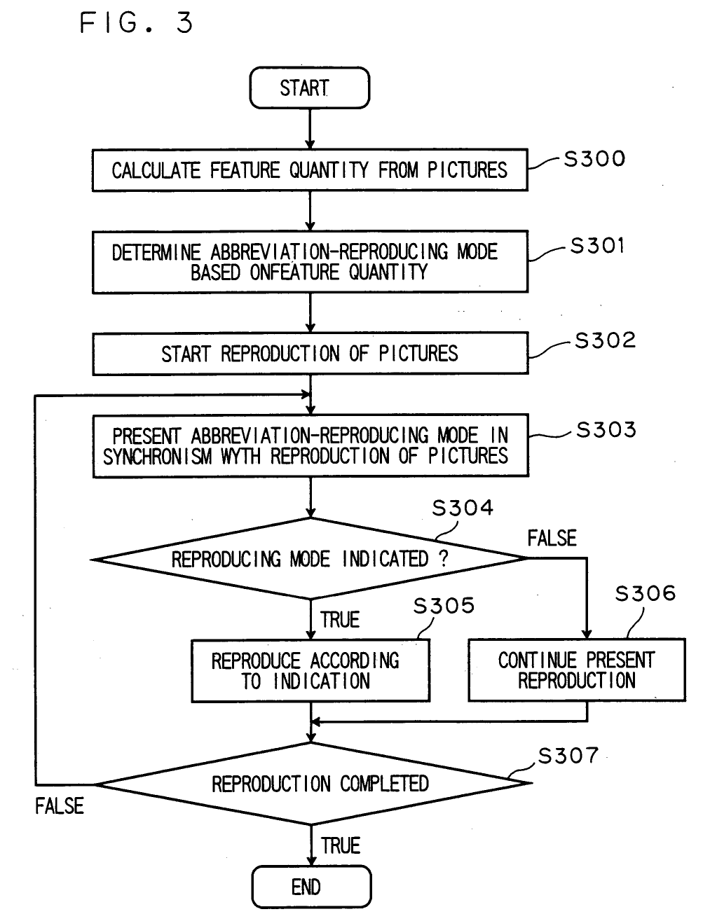

FIG. 3 shows the procedure of interactively abbreviation-reproducing pictures by using the video reproducing device according to the first embodiment by using a flowchart.

First, the feature quantity calculator 104 reads out audio data stored in the storage portion 100 to calculate sound pressure as a feature quantity (step S300).

The abbreviation-reproducing mode determining portion 105 subjects the calculated sound pressure to threshold-value processing to determine scenes, and determines an abbreviation- or accelerated-reproducing mode for each scene (step S301).

Thereafter, the reproduction controller 101 starts reproduction of pictures and sounds stored in the storage portion 100 (step S302)

The abbreviation-reproducing mode presenting portion 106 presents an abbreviation-reproducing mode in synchronism with the reproduction of pictures, and the reproducing portion 102 combines the presentation of the abbreviation-reproducing mode and the pictures and present them to an audience (step S303)

The audience consults the presentation of the abbreviation-reproducing mode and actually views and checks the pictures at the same time to determine whether the pictures should be subjected to abbreviation or accelerated reproduction. If the abbreviation-reproducing mode is instructed, the processing jumps to step S305. If not so, the processing jumps to step S306 (step S304).

In step S305, the reproduction controller 101 reproduces the pictures according to the instruction of the audience (step S305). In step S306, the reproduction controller 101 continues the present reproduction (step S306).

The processing is finished when the reproduction is completed. If not so, the processing returns to step S303 (step S307).

The video reproducing device of this embodiment enables the audience to interactively view the pictures while abbreviating the pictures.

### MODIFICATIONS OF FIRST EMBODIMENT

The present invention is not limited to the above embodiment, and various modifications may be made without departing from gist of the invention.

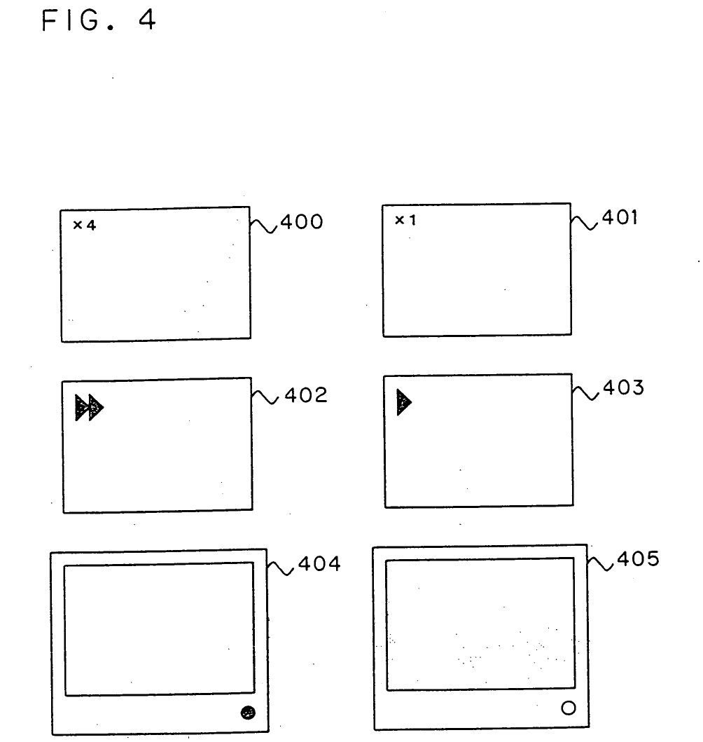

The modifications of the first embodiment will be described with reference to FIGS. 4 to 6.

(1) Modification 1

The abbreviation-reproduction of the first embodiment contains the unmagnified speed reproduction and the quadruple speed reproduction, however, the present invention is not limited to these mode. For example, the reproducing modes are not limited to two modes, and may contain three or more modes like the unmagnified speed reproduction, the quadruple speed reproduction, the decuple speed reproduction, etc. Or, the reproduction method (mode) may contain other modes such as a skip mode of skipping pictures till the next scene; a slow motion mode of reproducing pictures in slow motion; a more complicated mode of automatically starting the unmagnified speed reproduction when reproduction of a scene of the quadruple speed reproduction has been completed.

(2) Modification 2

The abbreviation-reproducing mode presenting portion 106 of the first embodiment presents the quadruple speed reproduction by a character sequence “×4” and presents the unmagnified speed reproduction by a character sequence “×1”. However, manner of presenting the reproduction modes is not limited to this, and any presentation method may be used insofar as it makes the audience perceive the abbreviation-reproducing mode. FIG. 4 shows a few examples of the presentation method. A reproduction screen 400 and are production screen 401 represent examples of the first embodiment. Meanwhile, For example, the quadruple speed reproduction may be represented by a figure of two triangles like a reproduction screen 402, and the unmagnified speed reproduction may be represented by one triangle like a reproduction screen 403. Alternatively, the quadruple speed reproduction may be represented by blinking a pilot lamp at the outside of the television screen, and the unmagnified speed reproduction may be represented by turning off the pilot lamp like a preproduction screen 404. The presentation method is not limited to the mode of appealing to the eye, but it may use sounds. For example, the quadruple speed reproduction may be represented by an alarm sound, and the unmagnified speed reproduction may be represented by soundlessness. When the number of the types of the abbreviation-reproducing mode is equal to three or more, the presentation may be carried out in connection with each type.

(3) Modification 3

The abbreviation-reproducing mode presenting portion 106 of the first embodiment presents an abbreviation-reproducing mode for a scene which is determined in the abbreviation-reproducing mode determining portion 105 during the reproduction of the scene concerned. However, presenting of the reproduction mode is not limited to this.

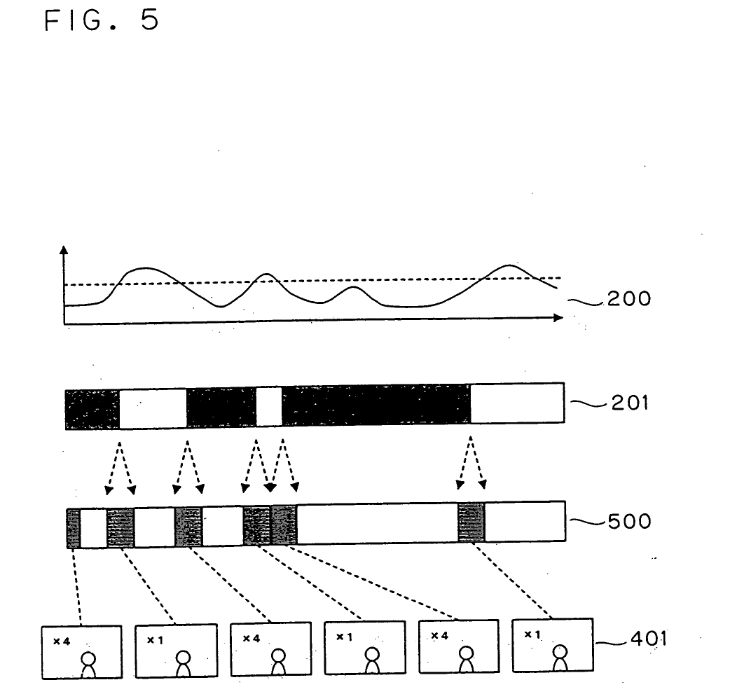

FIG. 5 shows another example of presenting the abbreviation-reproducing mode. A reproduction timing chart 500 at a third tier of FIG. 5 shows a section during which the abbreviation-reproducing mode is presented. The section does not correspond to the section determined in the abbreviation-reproducing mode determining portion 105 shown in a reproduction timing chart 201 in one-to-one correspondence. The reproducing mode is presented for ten seconds before and after a scene is switched and for ten seconds just after reproduction of the pictures is started. Because the abbreviation-reproducing mode is presented before a scene is reproduced, it can be notified beforehand whether the scene to be next reproduced is important or not. Because the presentation of the abbreviation-reproducing mode is stopped after a short time from the start of reproduction of a scene, the presentation is not remained to be displayed even after the indication or selection of the reproducing method by the audience is finished. Alternatively, the display of the presentation may be stopped at scenes after the reproducing mode is indicated or selected by the audience. In otherwise, the display of the presentation may be stopped in a fixed length of time after starting of inconsistency between presented one and actually adopted one, of the reproducing modes. In this way, unwanted or unnecessary presentation is avoided when the audience satisfies the actually adopted one of the reproducing mode.

(4) Modification 4

The abbreviation-reproducing mode determining portion 105 of the first embodiment determines the scene and the abbreviation-reproducing mode in advance before pictures are reproduced. However, the scene and the abbreviation-reproducing mode may be determined by foreseeing the pictures while the pictures are reproduced. In the case of long-time pictures, a long time needs to analyze the pictures, however, the reproduction of the pictures can be started without waiting until the analysis is finished.

(5) Modification 5

The abbreviation-reproducing determining portion 105 of the first embodiment determines one type of fixed abbreviation-reproducing mode. However, it may determine plural types of abbreviation-reproducing modes different in fineness, that is, extent of acceleration or abbreviation, or it may re-determine the abbreviation-reproducing mode by changing the analysis condition of the feature quantity on the basis of an audience's indication.

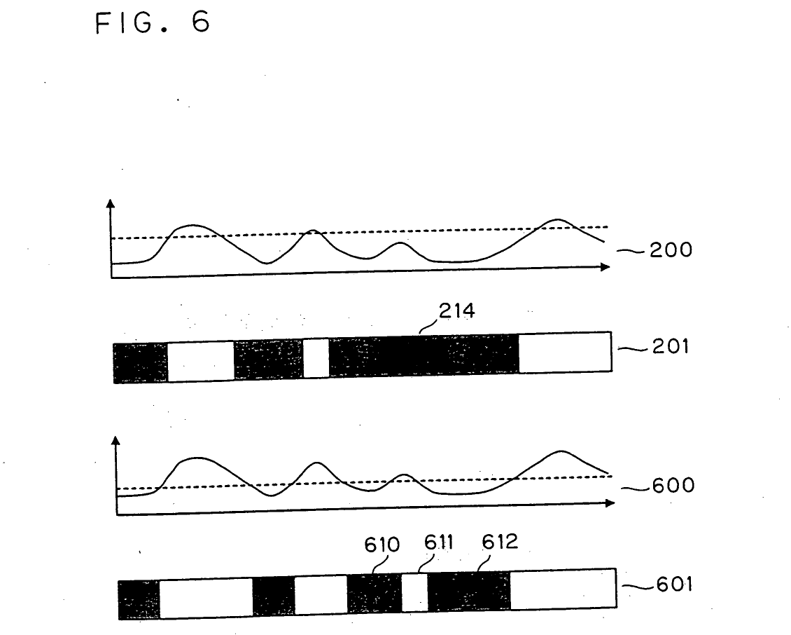

FIG. 6 shows an example of changing the analysis condition of the feature quantity.

(5-1) Modification 5-1

In the first embodiment, the sound pressure represented in the graph 200 is judged on the basis of the threshold value level represented by the broken line to section the scenes as shown in the reproduction timing chart 201 and to determine the abbreviation-reproducing mode. However, for example, the abbreviation-reproducing mode may be determined so that periods of the unmagnified speed reproduction are lengthened as shown in the reproduction timing of FIG. 6 when a threshold value level changing button added and attached to a remote controller is pressed by the audience during reproduction of pictures as to reduce level of the threshold value, which is indicated by the broken line, as shown in the graph 600.

(5-2) Modification 5-2

Plural sequences of abbreviation-reproducing modes like a reproduction timing chart 201 and a reproduction timing chart 601 are determined by using plural threshold values, and the audience operates a sequence change button added to a remote controller during reproduction of pictures to select any sequence of abbreviation-reproducing modes.

(5-3) Modification 5-3

In otherwise, when an operation of returning from the skip operation is carried out, the threshold value for only the section at scene just after the returning is reduced and then the reproduction is carried out. For example, it is assumed that the reproduction timing chart 201 is generated by using a threshold value indicated in a graph 200 and then the reproduction is carried out. In this case, for example when the audience perceives that lots of score points are added after a scene 214 is skipped and thus the scene concerned contains important pictures; and thus the audience instructs to return to the scene concerned and to reduce the threshold value as shown in a graph 600 to newly generate an unmagnified speed reproduction scene 611 within a period of the scene 214 and reproduce the pictures, so that the audience can view the scene 611 without skipping. The variation width of the threshold value may be set to a predetermined value or a value which is determined in advance by the audience. Or, the threshold value may be reduced until a predetermined number or more scenes each having a predetermined time or more are generated in the skipped scenes, whereby the optimal threshold value is automatically determined.

After the reproduction of the scene 611, the threshold value may be returned to the original one like the graph 200 when continuing the reproduction. Or, audience history may be stored and when the frequency of the returning operation from the skip exceeds some frequency, the threshold level may be automatically reduced.

(5-4) Modification 5-4 .

In the video reproducing device of the first embodiment, the analog feature quantity (sound pressure data) are read out and calculated by the feature quantity calculator 104 in advance; and the abbreviation-reproducing mode determining portion 105 subjects the calculated sound pressure to the threshold-value-based processing to determine an abbreviation-reproducing mode every scene.

In place of this manner, the feature quantity (sound pressure data) may be multi-valued and then the reproduction is carried out while subjecting the multi-valued feature quantity to the threshold-value-based processing. In this case, even when the threshold value is changed during reproduction, the processing or computing amount is greatly reduced as compared with a method of re-calculating the threshold-value-based processing on the basis of the analog feature amount.

(6) Modification 6

The feature quantity calculator 104 of the first embodiment calculates the sound pressure. However, it may calculate any feature quantity insofar as it is needed to determine an abbreviation-reproducing mode, and for example, the feature quantity may be the motion vectors of pictures, cuts, the color tone of pictures, camera work, the stereo mode of sounds, the magnitude of cheers, the magnitude of specific sounds such as impact sound, etc., closed caption or the like.

(7) Modification 7

The feature quantity calculator 104 of the first embodiment analyzes pictures and sounds stored in the storage portion 100 to calculate the feature quantity. However, any unit may be adopted insofar as it can achieve a feature quantity.

For example, a feature quantity is stored together with pictures or sounds in the storage portion in advance and the feature quantity calculator merely reads these data. It is effective to a case where analyzing of the feature quantity needs a lot of time and, in same time, an abbreviation-reproducing mode meeting audience's gusto can be determined in the abbreviation-reproducing determining portion 105. Or, the feature quantity may be received from a server by connecting to the server through the Internet.

(8) Modification 8

In the first embodiment, the reproducing device has been described as a DVD-based reproduction dedicated device. However, any device may be installed insofar as it has a function of reproducing pictures. For example, it may be installed in an HDD recorder, a cellular phone having a video reproducing function or the like.

(9) Modification 9

In the video reproducing device of the first embodiment, the feature quantity is calculated from the pictures. However, the feature quantity may be received through the Internet or the like to determine the abbreviation-reproducing mode from the feature quantity thus received as in the case of the first embodiment. In this case, the feature quantity calculator 104 is not needed.

For example, a feature quantity is calculated in connection with pictures stored in DVD in advance and stored in a server on the Internet, and the feature quantity is downloaded when the pictures are reproduced. It is effective to a case where computing amount is large and it is desired or needed to use a feature quantity having high precision.

(10) Modification 10

In the video reproducing device of the first embodiment, the abbreviation-reproducing mode is presented. However, the feature quantity calculated in the feature quantity calculator 104 may be directly presented to the audience. In this case, the abbreviation-reproducing mode determining portion 105 is not needed.

For example, since important pictures are frequently contained in a scene having large sounds, by directly presenting the magnitude of the sounds to the audience, the audience can estimate whether this scene is important or not. In this case, if the magnitude of sounds of a scene to be next reproduced is displayed in a graph style at an edge of the screen, the user can judge whether the pictures should be fast-forwarded or not after an important scene is finished.

(11) Modification 11

In the video reproducing device of the first embodiment, only the abbreviation-reproducing mode is presented to the audience, and the audience determines whether the abbreviation-reproduction should be carried out or not. However, the abbreviation-reproduction may be automatically carried out simultaneously with the presentation of the abbreviation-reproducing mode. In this case, the audience instructs whether the abbreviation-reproduction should be canceled or not.

For example, in a case where the reproducing method of a scene to be next reproduced is presented to the audience and a seemingly unimportant next scene would be automatically fast-forwarded at a time reproduction of the next scene is started, if important pictures are reproduced in a scene being reproduced at present and the audience estimates that important scenes are subsequently continued, the fast-forwarding of the next scene may be canceled.

As compared with the case where the abbreviation-reproducing mode is indicated or selected by the audience as in the case of the video reproducing device of the first embodiment, the load of the audience is greatly reduced when the frequency of indications or instructions is low.

### SECOND EMBODIMENT

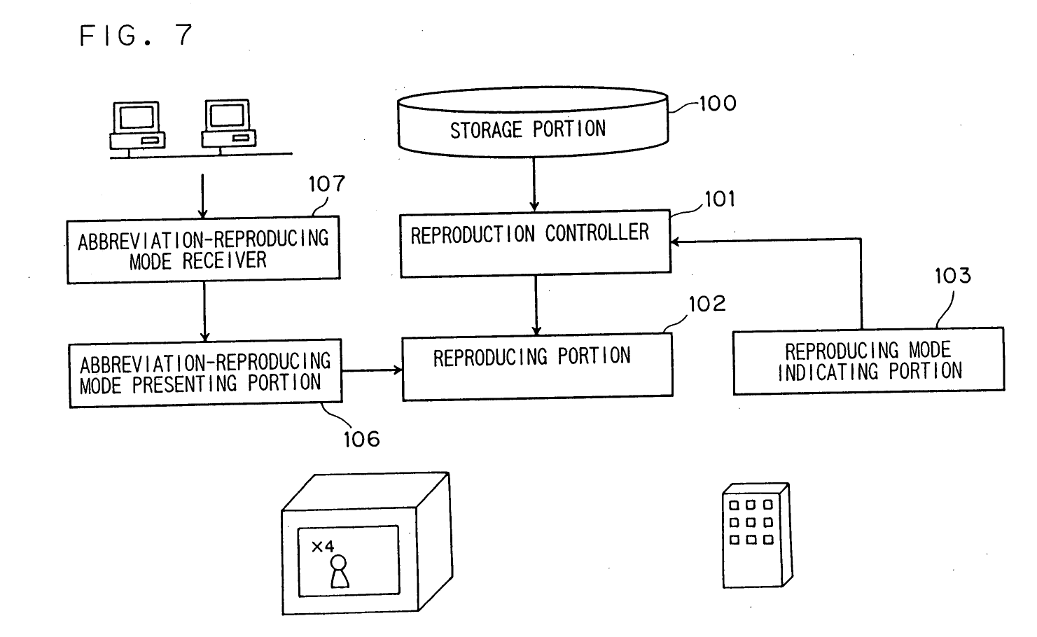

A video reproducing device of a second embodiment of the present invention will be described with reference to FIGS. 7 to 9.

In the video reproducing device of the second embodiment, the abbreviation-reproducing mode is received from the Internet or the like unlike the video reproducing device of the first embodiment in which the pictures are analyzed and then the abbreviation-reproducing mode is determined.

(1) Summary of Abbreviation-Reproduction of Video Reproducing Device

FIG. 7 is a diagram showing the video reproducing device according to the second embodiment.

The video reproducing device of the second embodiment is constructed by modifying the construction of the first embodiment shown in FIG. 1 in a manner as removing the feature quantity calculator 104 and adding an abbreviation-reproducing mode receiver 107 in place of the abbreviation-reproducing mode determining portion 105.

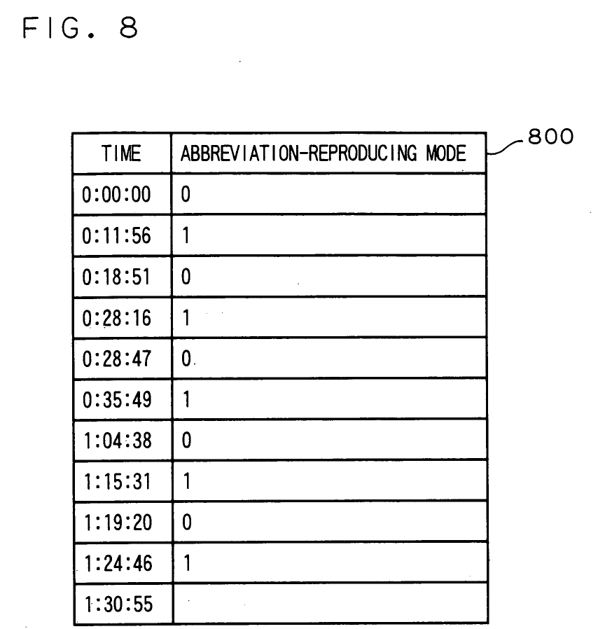

The abbreviation-reproducing mode receiver 107 is constructed by a reception circuit connected to the Internet, and receives an abbreviation-reproducing mode from a server. FIG. 8 shows an example of the abbreviation-reproducing mode thus received. The column of the time represents the head or start time of each scene, and represents duration after beginning of reproducing the pictures. The column of the abbreviation-reproducing mode represents an abbreviation-reproducing mode by a numeral. In the case of “0”, it represents the quadruple speed reproduction, and in the case of “1”, the unmagnified speed reproduction. In this example, it is represented that a scene from the time of 0:11:56 to the time of 0:18:51 would be subjected to the unmagnified speed reproduction and a scene from the time of 0:28:47 to the time of 0:35:49 would be subjected to the quadruple speed reproduction.

The abbreviation-reproducing mode presenting portion 106 presents an abbreviation-reproducing mode to the audience on the basis of the abbreviation-reproducing mode received by the abbreviation-reproducing mode receiver 107, and the other processing is carried out in the same manner as the first embodiment.

(2) Procedure of Abbreviation-Reproducing Pictures

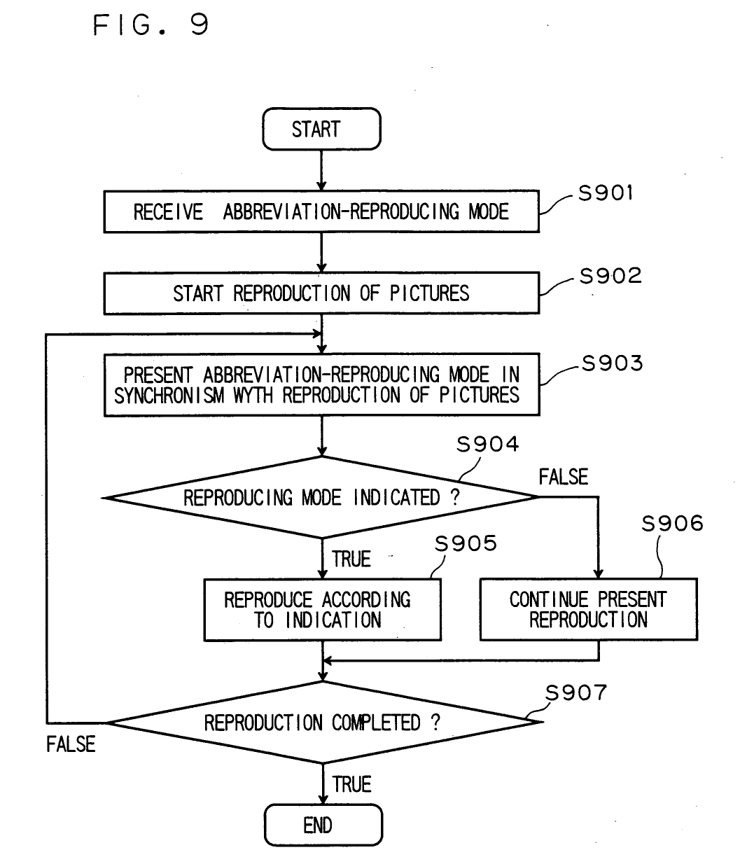

FIG. 9 is a flowchart showing the procedure of interactively abbreviation-reproducing pictures by using the video reproducing device.

First, the abbreviation-reproducing mode receiver 107 receives an abbreviation-reproducing mode from a server on the Internet (step S901).

Thereafter, the reproduction controller 101 starts to reproduce pictures and sounds stored in the storage portion 100 (step S902).

The abbreviation-reproducing mode presenting portion 106 presents the abbreviation-reproducing mode in synchronism with the reproduction of the pictures, and the reproducing portion 102 combines the presentation of the abbreviation-reproducing mode and the pictures and presents the composite data to the audience (step S903).

The audience consults the indication of the abbreviation-reproducing mode and simultaneously views and checks the pictures actually to determine whether the pictures should be subjected to abbreviation-reproduction. When the abbreviation-reproducing mode is indicated as adopted by the audience, the processing jumps to step S905, and if not so, the processing jumps to step S906 (step S904).

In step S905, the reproduction controller 101 reproduces the pictures according to the instruction of the audience (step S905). In step S906, the reproduction controller 101 continues the present reproduction (step S906).

The reproduction is ended when completed or when it is not completed, the procedure returns to step 903 (step S907)

As described above, according to the second embodiment, even video reproducing equipment having no picture analyzing capability can view/listen to the pictures while abbreviating the pictures interactively with the audience.

### MODIFICATION OF SECOND EMBODIMENT

The abbreviation-reproduction receiver 107 of the second embodiment receives the abbreviation-reproducing mode from the server on the Internet, however, any unit may be used insofar as it can receive the abbreviation-reproducing mode.

For example, the abbreviation-reproducing mode may be stored together with the pictures or the sounds in the storage portion 100, and then it may be read out. Or, an abbreviation-reproduction method stored in a memory card may be copied.

The abbreviation-reproduction receiver. 107 of the second embodiment receives one type of abbreviation-reproducing mode, however, it may receive plural types of abbreviation-reproducing modes.

### THIRD EMBODIMENT

In the third embodiment, only the sounds are processed. For example, it is usable in a case where the content of a conference is recorded in DVD or a memory and afterwards subjected to abbreviation-reproduction.

(1) Construction of Audio Reproducing Device

The construction of the audio reproducing device according to a third embodiment is substantially the same as the first embodiment shown in FIG. 1.

That is, an audio reproducing device constructed by: a storage portion 100 for storing sounds; a reproduction controller 101 for controlling reproduction of sounds; a reproducing portion 102 for outputting sounds under the control and a reproducing method indicating portion 103 which allows a user to indicate a reproduction method such as unmagnified speed reproduction, fast-forward reproduction or the like; and is further comprised of: a feature quantity calculator 104 for calculating a feature quantity from the sounds stored; an abbreviation-reproducing mode determining portion 105 for determining an abbreviation-reproducing mode of a scene from the feature quantity thus calculated; and an abbreviation-reproducing mode presenting portion 106 for presenting to the audience the abbreviation-reproducing mode of the scene during reproduction of sounds on the basis of the abbreviation-reproducing mode thus determined.

(2) Processing Procedure

The processing procedure of this embodiment is substantially identical to that of the first embodiment, and thus only the different portion will be described hereunder.

The feature quantity calculator 104 is constructed by an audio decoder circuit, and reads out audio data stored in the storage portion 100 to calculate sound pressure.

The abbreviation-reproducing mode determining portion 105 is constructed by an electronic circuit. As in the case of the first embodiment, the abbreviation-reproducing mode determining portion sections sounds into scenes as scenes to be reproduced at a quadruple speed and scenes to be reproduced at an unmagnified speed.

The abbreviation-reproducing mode presenting portion 106 is constructed by a sound generating circuit. When the quadruple speed reproduction is represented, dialing tone is continuously generated like “pip-pip-pip”. When the unmagnified speed reproduction is represented, no sound is generated.

The storage portion 100 is constructed by DVD or a memory and a reading device.

The reproduction controller 101 is constructed by an audio decoder circuit. It reads out and decodes sounds stored in the storage portion 100, and reproduces the sounds according to an instruction of the reproducing method indicating portion 103. The reproducing portion 102 is constructed by an amplifying circuit and a speaker. It combines the sounds decoded in the reproduction controller 101 and the sounds generated by the abbreviation-reproducing mode presenting portion 106 and reproduces the composite data thus achieved.

In the example of FIG. 2, in the case of the quadruple speed reproduction, the sounds stored in the storage portion 100 is combined with dialing tone like “pip-pip-pip” and reproduced. Therefore, the user perceives that this portion should be fast-forwarded. Likewise, the user perceives that the unmagnified speed reproduction is supposed to be carried out if the dialing tone is ceased.

As described above, the audio reproducing device of the third embodiment enables the user to listen to the sounds while abbreviating or accelerating their reproduction interactively with the user.

What is claimed is:

1. A reproducing device for reproducing pictures or sounds comprising:
an acquiring unit configured to acquire a time-sequential feature quantity from at least one of, the pictures, the sounds and information appended to the pictures or sounds; and
a feature presenting unit configured to present the feature quantity to an audience in association with position of the pictures or sounds under reproduction or with position of the pictures or sounds to be next reproduced.

2. A reproducing device for reproducing pictures or sounds comprising:
an acquiring unit configured to acquire a time-sequential feature quantity from at least one of, the pictures, the sounds and information appended to the pictures or sounds;
a determining unit configured to determine scenes on basis of the feature quantity and a predetermined calculation condition and determines a time-wise shortened reproducing mode of carrying out accelerated or abbreviated reproduction for each scene; and
a mode presenting unit configured to present the time-wise shortened reproducing mode to an audience in association with a scene of the pictures or sounds under reproduction or with a scene to be next reproduced.

3. A reproducing device for reproducing pictures or sounds comprising:
a receiving unit configured to receive scenes of the pictures or sounds and a time-wise shortened reproducing mode of carrying out accelerated or abbreviated reproduction for each of the scene; and
a mode presenting unit configured to present the time-wise shortened reproducing mode to an audience in association with one of the scenes of the pictures or sounds under reproduction or with other one of the scenes to be next reproduced.

4. The reproducing device according to claim 2, further comprising:
a selection inputting unit configured to input a selection of the audience, the selection being one of a plurality of the time-wise shortened reproducing modes presented to the audience; and
a reproduction controlling unit configured to realize a time-wise shortened reproducing in accordance with the selection.

5. The reproducing device according to claim 2, further comprising:
an automatic adoption unit configured to automatically adopt the time-wise shortened reproducing mode presented to the audience,
a cancellation inputting unit configured to input, from the audience, a cancellation of the automatic adoption; and
a reproduction controlling unit configured to reproduce the pictures or sounds according to the time-wise shortened reproducing mode adopted automatically and restore a reproducing mode adopted before the automatic adoption when the cancellation is input.

6. The reproducing device according to claim 3, further comprising:
a selection inputting unit configured to input a selection of the audience, the selection being one of a plurality of the time-wise shortened reproducing modes presented to the audience; and
a reproduction controlling unit configured to realize a time-wise shortened reproducing in accordance with the selection.

7. The reproducing device according to claim 3, further comprising:
an automatic adoption unit configured to automatically adopt the time-wise shortened reproducing mode presented to the audience,
a cancellation inputting unit configured to input, from the audience, a cancellation of the automatic adoption; and
a reproduction controlling unit configured to reproduce the pictures or sounds according to the time-wise shortened reproducing mode adopted automatically and restore a reproducing mode adopted before the automatic adoption when the cancellation is input.

8. The reproducing device according to claim 2, wherein
the determining unit determines a plurality of the time-wise shortened reproducing modes;
the mode presenting unit presents the plurality of the time-wise shortened reproducing modes thus determined; and
the reproducing device is further equipped with:
a selection inputting unit configured to input a selection of the audience, the selection being one of the time-wise shortened reproducing modes presented to the audience; and
a reproduction controlling unit configured to carry out reproduction of the pictures or sounds in accordance with the selection.

9. The reproducing device according to claim 3, wherein the receiving unit receives a plurality of the time-wise shortened reproducing modes;
the mode presenting unit presents the plurality of the time-wise shortened reproducing modes thus received; and
the reproducing device is further equipped with:
a selection inputting unit configured to input a selection of the audience, the selection being one of the time-wise shortened reproducing modes presented to the audience; and
a reproduction controlling unit configured to carry out reproduction of the pictures or sounds in accordance with the selection.

10. The reproducing device according to claim 2, wherein the determining unit includes a unit configured to change the calculation condition, and determines the time-wise shortened reproducing mode on basis of the calculation condition thus changed.

11. The reproducing device according to claim 10, wherein
the acquiring unit converts the feature quantity to multi-valued feature quantity; and
the determining unit determines one of the time-wise shortened reproducing mode on basis of such changed calculation condition and the multi-valued feature quantity.

12. There producing device according to claim 10, wherein, when the audience re-reproduces the pictures or sounds while timely retracing, the determining unit re-determines the time-wise shortened reproducing mode on basis of such changed calculation condition for retraced section of the pictures or sounds or for all the sections subsequent to the retraced section.

13. The reproducing device according to claim 2,
further comprising a storage unit configured to store history of instructions made by the audience on the time-wise shortened reproducing mode,
wherein, when the audience re-reproduces the pictures or sounds while timely retracing, the determining unit re-determines the time-wise shortened reproducing mode on basis of the history of instructions for retraced section of the pictures or sounds or for all the sections subsequent to the retraced section.

14. The reproducing device according to claim 1, wherein the acquiring unit calculates the feature quantity from the scene under reproduction or the scene to be next reproduced.

15. The reproducing device according to claim 1, wherein the acquiring unit receives the feature quantity from outside of the reproducing device.

16. The reproducing device according to claim 2, wherein the acquiring unit calculates the feature quantity from the scene under reproduction or the scene to be next reproduced.

17. The reproducing device according to claim 2, wherein the acquiring unit receives the feature quantity from outside of the reproducing device.

18. The reproducing device according to claim 2, wherein the time-wise shortened reproducing mode is at least one of:
a reproducing of the pictures or sounds at unmagnified or original speed;
a reproducing of the pictures or sounds while skipping some parts of the pictures or sounds;
an accelerated reproducing of the pictures or sounds while fast-forwarding; and
a mode of carrying out the accelerated reproduction and automatically returning to the reproducing at unmagnified speed when the last of a certain scene comes.

19. The reproducing device according to claim 3, wherein the time-wise shortened reproducing mode is at least one of:
a reproducing of the pictures or sounds at unmagnified or original speed;
a reproducing of the pictures or sounds while skipping some parts of the pictures or sounds;
an accelerated reproducing of the pictures or sounds while fast-forwarding; and
a mode of carrying out the accelerated reproduction and automatically returning to the reproducing at unmagnified speed when the last of a certain scene comes.

20. The reproducing device according to claim 1, wherein the feature presenting unit presents the feature quantity:
(1) by using at least one of a figure, a graph and a character string, on at least one of, a main screen of the reproducing device, a small screen at outside of the main screen, and a small screen on a remote controller of the reproducing device;
(2) by changing turn-on state of at least one of, a lamp at outside of the main screen and a lamp on the remote controller; or
(3) by reproducing at least one of sounds and voice, from a sound output unit of the reproducing device.

21. The reproducing device according to claim 2, wherein the mode presenting unit presents the time-wise shortened reproducing mode:
(1) by using at least one of a figure, a graph and a character string, on at least one of, a main screen of the reproducing device, a small screen at outside of the main screen, and a small screen on a remote controller of the reproducing device;
(2) by changing turn-on state of at least one of, a lamp at outside of the main screen and a lamp on the remote controller; or
(3) by reproducing at least one of sounds and voice, from a sound output unit of the reproducing device.

22. The reproducing device according to claim 3, wherein the mode presenting unit presents the time-wise shortened reproducing mode:
(1) by using at least one of a figure, a graph and a character string, on at least one of, a main screen of the reproducing device, a small screen at outside of the main screen, and a small screen on a remote controller of the reproducing device;
(2) by changing turn-on state of at least one of, a lamp at outside of the main screen and a lamp on the remote controller; or
(3) by reproducing at least one of sounds and voice, from a sound output unit of the reproducing device.

23. The reproducing device according to claim 2, wherein the mode presenting unit presents the reproducing mode at a time period of at least one or any combination of following:
(1) a whole period during reproduction of the scene,
(2) a certain length of period from beginning of the reproduction of the scene,
(3) a certain length of period before beginning of the reproduction of the scene,
(4) a whole period during which presented one of the reproduction mode for the scene is inconsistent with one being carried out for reproducing the scene,
(5) a certain length of period from beginning of such in consistence between the presented one and the one being carried out for reproducing the scene.

24. The reproducing device according to claim 3, wherein the mode presenting unit presents the reproducing mode at a time period of at least one or any combination of following:
(1) a whole period during reproduction of the scene,
(2) a certain length of period from beginning of the reproduction of the scene,
(3) a certain length of period before beginning of the reproduction of the scene,
(4) a whole period during which presented one of the reproduction mode for the scene is inconsistent with one being carried out for reproducing the scene,
(5) a certain length of period from beginning of such in consistence between the presented one and the one being carried out for reproducing the scene.

25. The reproducing device according to claim 4, wherein the selection inputting unit is equipped with:
(1) inputting units respectively presenting the reproduction modes and having one-to-one correspondence to ones presented by the mode presenting unit, or
(2) a selection presenting unit configured to present only a selection whether to adopt an unmagnified speed reproduction or not as to allow an audience to make the selection.

26. A reproducing method for reproducing pictures or sounds comprising:
acquiring a time-sequential feature quantity from at least one of, the pictures, the sounds and information appended to the pictures or sounds; and
presenting the feature quantity thus acquired to an audience in connection with position of the pictures or sounds under reproduction or with position of the pictures or sounds to be next reproduced.

27. A reproducing method for reproducing pictures or sounds comprising:
acquiring a time-sequential feature quantity from at least one of, the pictures, the sounds and information appended to the pictures or sounds;
determining scenes on basis of the feature quantity thus acquired and a predetermined calculation condition and determining a time-wise shortened reproducing mode for each of the scenes; and
presenting the time-wise shortened reproducing mode thus determined to an audience in connection with a scene of the pictures or sounds under reproduction or with a scene to be next reproduced.

28. A reproducing method for reproducing pictures or sounds comprising:
receiving a time-wise shortened reproducing mode of carrying out accelerated or abbreviated reproduction for each of the scenes; and
presenting the time-wise shortened reproducing mode thus received to an audience in connection with one of the scenes under reproduction or with other one of the scenes to be next reproduced.

29. A program product for making a computer implement a reproducing method for reproducing pictures or sounds, the program product comprising instructions of:
acquiring a time-sequential feature quantity from at least one of, the pictures, the sounds and information appended to the pictures or sounds; and
presenting the feature quantity thus acquired to an audience in connection with position of the pictures or sounds under reproduction or with position of the pictures or sounds to be next reproduced.

30. A program product for reproducing pictures or sounds, comprising instructions of:
acquiring a time-sequential feature quantity from at least one of, the pictures, the sounds and information appended to the pictures or sounds;
determining scenes on basis of the feature quantity thus acquired and a predetermined calculation condition and determining a time-wise shortened reproducing mode for each of the scenes; and
presenting the time-wise shortened reproducing mode thus determined to an audience in connection with a scene of the pictures or sounds under reproduction or with a scene to be next reproduced.

31. A program product for reproducing pictures or sounds, comprising instructions of:
receiving a time-wise shortened reproducing mode of carrying out accelerated or abbreviated reproduction for each of the scenes; and
presenting the time-wise shortened reproducing mode thus received to an audience in connection with one of the scenes under reproduction or with other one of the scenes to be next reproduced.
